(19) United States
(12) Patent Application Publication
(10) Pub. No.: US 2008/0157978 A1
(43) Pub. Date: Jul. 3, 2008

(54) METHOD AND SYSTEM TO AID USERS IN INSTALLATION OF PLUG-IN DEVICES

(75) Inventors: MICHAEL D. KOTZIN, BUFFALO GROVE, IL (US); WILLIAM P. ALBERTH, PRAIRIE GROVE, IL (US); ARMIN W. KLOMSDORF, LIBERTYVILLE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/617,006

(22) Filed: Dec. 28, 2006

(51) Int. Cl. G08C 21/00

(52) U.S. Cl. 340/572.8

(57) ABSTRACT

A method includes providing a cable or component having a first type of connector attached thereto. A device is provided having at least one second type of connector, capable of mating with the first type of connector, attached thereto. The cable or component is detected as proximate the device. An indication is provided that includes instructions as to how to connect the first type of connector and the second type of connector.

### FIELD

The present application relates to electronic devices, and more particularly to electronic devices that include ports and/or slots with which to interface with other devices.

### BACKGROUND

Many electronic devices include ports or slots, which allow users to connect other devices or components to those devices. For instance, an audio visual receiver includes a multitude of jacks to which users can connect other devices, such as DVD players, DVR boxes, amplifiers and the like. Personal computers include a number of ports (e.g. USB, Fire Wire, parallel, serial, etc.) to which users connect peripherals. Portable electronic devices, such as laptops, cellular phone, media players, and the like also utilize different combinations of the above ports. In addition, portable devices also include card slots with which users can attach memory cards or other devices.

Despite the advantages of this connectivity, many consumers find it difficult to actually attach peripherals and other devices to their user equipment. The sheer number of ports can be confusing, and even when a particular port is found, it can be difficult to determine how a device should be plugged-in. Accordingly, what is needed is a method and system to aid a user in installation of plug-in devices.

### BRIEF DESCRIPTION OF THE DRAWINGS

For the purpose of facilitating an understanding of the subject matter sought to be protected, there are illustrative embodiments in the accompanying drawing, from an inspection of which, when considered in connection with the following description and claims, the subject matter sought to be protected, its construction and operation, and many of its advantages should be readily understood and appreciated

FIG. 1 depicts a functional block diagram of one example of a system to aid a user in the installation of plug-in devices.

FIG. 2 depicts a functional block diagram of one example of a system to aid a user in the installation of plug-in devices.

### DETAILED DESCRIPTION

In one example, a method is provided. A cable is provided having a first type of connector attached thereto. A device is provided having at least one second type of connector, capable of mating with the first type of connector. A detection is made that the cable is proximate the device. An indication is provided, from the device, which includes instructions as to how to connect the first type of connector and the second type of connector.

In one example, a device is provided. A device is provided that includes at least one port configured to receive at least one plug-in component. A detector identifies when a plug-in component is proximate the device. A processor component is configured to identify the plug-in component. An output device provides an indication as to how the plug-in component should be inserted into the port.

In another example, a method is provided. An electronic device is provided that has a port for receiving a removable component card. A card is detected as proximate the device. An indication, from the device, is provided that includes an instruction as to how to insert the card into the device.

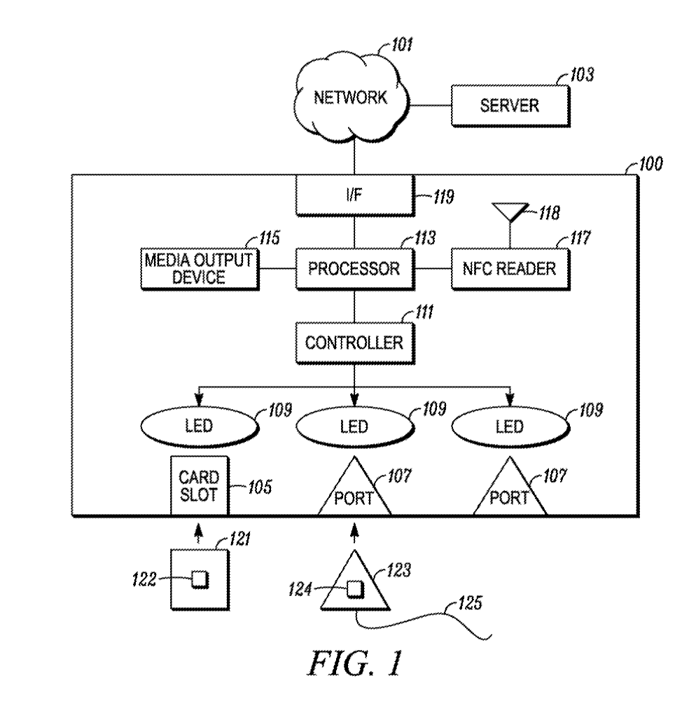

Referring to FIG. 1, an illustrative embodiment of a device 100 is provided. Device 100 in one example comprises a portion of an electronic computing device. Device 100 could be a stand alone device or a device capable of communicating with one or more other devices, either directly or over a network. Examples of such devices include, but are not limited to, mobile phones, pagers, radios, personal digital assistants (PDAs), mobile data terminals, desktop computers, laptop computers, application specific gaming devices, video gaming devices, audio visual receivers, DVD players, cable boxes, DVRs, and combinations or subcombinations of these devices. Such devices generally include components such as processors, controllers, memory components, user interface devices, data transmission logic, network interfaces, antennas, and the like. The design and operation of these devices is well known so a detailed description of each possibility will be omitted. However, those components necessary to fully describe the claimed subject matter are shown.

Further referring to FIG. 1, the components of device 100 are formed of one or more computer software and/or hardware components. A number of such components can be combined or divided. In one example, an exemplary component of each device employs and/or comprises a series of computer instructions written in or implemented with any of a number of programming languages, as will be appreciated by those skilled in the art.

Device 100 can employ at least one computer-readable signal-bearing medium. An example of a computer-readable signal-bearing medium is a recordable data storage medium, such as a magnetic, optical, and/or atomic scale data storage medium. In another example, a computer-readable signal-bearing medium is a modulated carrier signal transmitted over a network. A computer-readable signal-bearing medium can store software and/or logic components that are employable to carry out the functionality described herein.

Device 100 could be a stand alone device or it could be capable of communication, with other devices 103, over one or more wireless or wired networks 101 (e.g., a Local Area Network (“LAN”), a Wide Area Network (“WAN”), a wireless LAN, a wireless WAN, the Internet, a wireless telephone network, etc.). Examples of wireless networks include networks that employe one or more radio access technology (RAT). Examples of RATs include, but are not limited to, UTRA (UMTS Terrestrial Radio Access), CDMA2000®, Global System for Mobile Communications (GSM), GSM EDGE Radio Access (GERAN), Wimax. RATs in one example use spread spectrum modulation formats (e.g. CDMA, OFDMA) and non-spread spectrum (e.g. GSM) modulation formats and variations and evolutions thereof. In addition, the device 100 could be capable of communicating directly with other devices through the formation of ad hoc networks. Such networks can be formed through the utilization of wired or wireless (e.g. Bluetooth) technology.

Referring further to FIG. 1, device 100 includes at least one card slot 105, at least one port 107, at least one visual indicator 109 (in this case LED), a controller 111, a processor 113, a media output device 115, a Near Field Communication (NFC) reader 117, and an interface 119.

The preceding components are shown for exemplary purposes only and different variations are possible, as will be further understood herein. For instance, the device 100 could include only a single port 107 and no card slot 105, or the device could include only a single card slot 105 and no ports 107. The LEDs 109 could be excluded altogether in favor of media output device, or vice versa. Furthermore, different configurations of LED's 109 are possible. For instance, a plurality of LEDs could be configured in the shape of an arrow pointing to each card slot 105 or port 107. In one example, NFC reader 117 is utilized to read radio frequency identification (RFID) tags. In another example, NFC reader 117 could be replaced with a Bluetooth receiver or a WiFi receiver. In a further example, the functionality of controller 111 could be performed by processor 113. Finally, card slots 105 and ports 107 are shown for exemplary purposes only and should not be construed as limiting. The subject matter of the present application extends to a device having any type of connection point or connector for mating with the connector of a cable, another device or a module.

Referring further to FIG. 1, card slot 105 in one example is utilized to receive an electronic component card 121, such as a flash memory card, a PCMCIA card, a SIM card, or any other type of card utilized by an electronic device. Port 107 in one example is utilized as a connection point or connector to attach another electronic device or cable to device 100. Exemplary ports include, but are not limited to various connectors or plugs 123, such as audio jacks, telephone, Ethernet jacks, Universal Serial Bus (USB) ports, IEEE 1394 ports, S-Video ports, coaxial cable (e.g. RG-6) jacks, and so forth. Ports 107 also include variations and evolutions of the ports in existence today. Finally, it should be noted that port 107 could be either the male end or the female end of the connector.

Referring still to FIG. 1, controller 111 in one example is a lighting controller to control the illumination of LEDs 109. Processor 113 in one example is the CPU that controls the overall functionality of device 100. Media output device 115 in one example is a combination of an audio and visual output device, such as an LCD/speaker combination. In another example, media output device 115 is one of these devices. NFC reader 117 in one example is an RFID reader. NFC reader 117 includes an antenna 118 for detecting RFID chips or tags.

Further referring to FIG. 1, component card 121 includes a chip 122 that is utilized by device 100 to detect that card 121 is proximate device 100. Similarly, plug 123 includes a chip 124 that is utilized by device 100 to detect that plug 123 is proximate device 100. Chips 122, 124 in one example are active devices, such as radio transmitters, Bluetooth chipsets, WiFi chipsets, etc. In another example, chips 122, 124 are passive devices, such as RFID tags. The determination of whether or not a card 121 or a plug 123 is proximate device 100 will depend on the NFC technology used and for the operating parameters established by the manufacturers and users of device 100. For example, for NFC, the connector will be detected at about 3 inches.

Referring further to FIG. 1, an exemplary description of the operation of device 100 will now be described for illustrative purposes. In one example, a user of device 100 wants to insert card 121 and/or plug 123 (which is attached to cable 125) into device 100. Accordingly, the user will move card 121 or plug 123 toward device 100. When card 121 or plug 123 comes within range, the NFC reader 117 will detect the unique identifying signal sent from chip 122 or 123, either actively or passively through the interaction of the RFID coil with signals emitting from antenna 118. NFC reader will then send a signal to processor 113 with the identifying signal from chip 122 or 123. Processor 113 will identify the card 121 or plug 123. For example, processor 113 will determine that card 121 is a certain type of flash card or that plug 123 is a USB connector. Processor will then send a signal to controller 111 instructing it to provide an indication of the particular port 107 or slot 105 in which the card 121 or plug 123 should be inserted. In one example, the indication could be the lighting of the LED 109 corresponding to card slot 105, in the case of card 121, or the lighting of LED 109 corresponding to port 107, in the case of plug 123. In another example, a visual indication could be provided on media output device 115. For example, a diagram or picture depicting the port configuration of device 100 could be shown on an LCD and animated instructions, showing the user how to plug a card or plug 123, could be provided. Such animation could include audio output as well. In another example, audio output could be provided from a speaker. The audio output could include verbal instructions as to how to attach card 121 or plug 123 into device 100.

Finally, it should be noted that the indication, instructing the user how to insert card 121 or plug 123 into device 100, can be rudimentary (e.g. a single LED) or complex (detailed instructions). Such instructions could be contained within a memory of device 100 or hardwired into controller. Further, the identity of the various plugs and cards could be stored in a table within memory with the corresponding ports or slots to which they are compatible. Accordingly, upon identifying the particular card 121 or plug 123, which is proximate device 100, the processor 113 could perform a table look up to determine which slot 121 or port 123 it should be attached to. In another example, the identity of plug 121 or card 123 and the instructions for attaching it to device 100 could reside on server 103, which is remote from device 100. Processor 113, upon receiving the identifying signal from NFC reader 117, could send a request over network 101 to server 103 requesting the identity of card 121 or plug 123 and instructions for attaching it to device 100. Server 103 would send the identity and/or instructions back to processor 113, which would then provide an indication to user as set forth above.

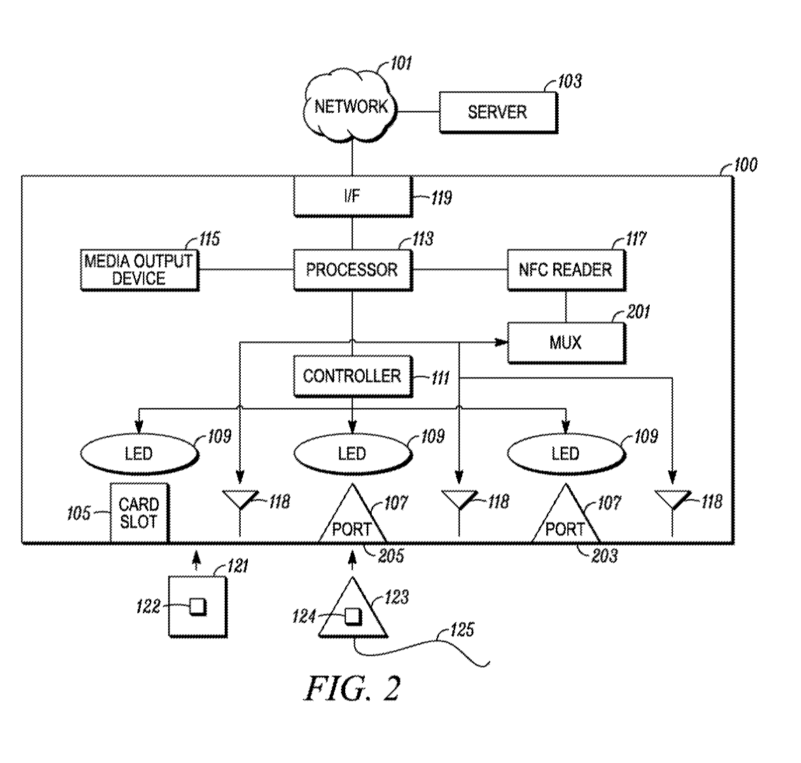

Referring to FIG. 2, another example of device 100 is shown for illustrative purposes. Device 100 includes an antenna 118 for each slot 105 and port 107. The antennas 118 are each attached to a multiplexer 201. Card reader 117 in one example periodically polls each antenna 118. Accordingly, as a user moves a card 121 or plug 123 near over the device. An indication will be provided to the user as the user nears the particular slot 105 or port 107 to which the card 121 or plug 123 can attach.

For instance, if the user were to move the plug toward port 203, during a poll from NFC reader 117, antenna 118 would interact with chip 124 and a signal would be sent through MUX 201 and NFC reader 117 to processor 113. Processor 113 would determine the identity of plug 123 and also that plug 123 should not be plugged into port 203. Accordingly, the processor 113 would send no visual indication to the LED corresponding to port 203. In another example, the processor 113 would tell controller 111 to send a visual indication for the user not to use port 203. For instance, the controller 111 could illuminate a red LED.

Conversely, if the user were to move the plug toward port 204, during a poll from NFC reader 117, antenna 118 would interact with chip 124 and a signal would be sent through MUX 201 and NFC reader 117 to processor 113. Processor 113 would determine the identity of plug 123 and also that plug 123 should be plugged into port 205. Accordingly, the processor 113 would tell controller 111 to light an LED corresponding to port 205.

In a further example, LEDs 109 could be used to provide instructions as to how to insert card 121 or plug 123 into a slot/port. For instance, multiple antennas 118 could be use to determine the orientation of the card 121 and plug 123. If the user were orienting it the correct way, the LED could flash, and if the user were not orienting it the correct way, the LED would be solid. Further, the LED could flash faster as the user moved the card 121 or plug 123 closer to the slot/port.

While particular embodiments have been shown and described, it will be apparent to those skilled in the art that changes and modifications may be made without departing from the principles set forth herein. The matter set forth in the foregoing description and accompanying drawings is offered by way of illustration only and not as a limitation.

1. A method, comprising:
providing a cable having a first type of connector attached thereto;
providing a device having at least one second type of connector, capable of mating with the first type of connector, attached thereto;
detecting that the cable is proximate the device; and
providing an indication, that includes instructions as to how to connect the first type of connector and the second type of connector.

2. The method of claim 1, wherein the step of providing the cable comprises:
providing the cable to include a radio frequency identification (RFID) attached thereto.

3. The method of claim 2, wherein the step of providing further comprises:
positioning the RFID within the first type of connector.

4. The method of claim 2, wherein the step of providing the device comprises:
providing the device to include a reader that is configured to detect the RFID.

5. The method of claim 1, wherein the step of providing the indication comprises:
providing a visual indication if the first type of connector has a correct orientation with respect to the second type of connector.

6. The method of claim 1, wherein the step of providing comprises:
providing an audible indication if the first type of connector has a correct orientation with respect to the second type of connector.

7. The method of claim 1, further comprising:
retrieving instructions as to how to position the first connector with respect to the second connector.

8. The method of claim 7, wherein the step of retrieving instructions comprises:
requesting the instructions from another device over a network; and
receiving the instructions over the network.

9. The method of claim 7, wherein the step of providing the indication comprises:
outputting the instructions from a media device.

10. A method, comprising:
providing an electronic device having a port for receiving a removable component;
detecting that a component is proximate the device; and
providing an indication, from the device, that includes instructions as to how to insert the component into the device.

11. A device comprising:
at least one port configured to receive at least one plug-in component;
a detector that identifies when a plug-in component is proximate the device; and
a processor component configured to identify the plug-in component; and
an output device to provide an indication as to how the plug-in component should be inserted into the port.

12. The device of claim 11, wherein the port is configured to receive a plug attached to a cable.

13. The device of claim 11, wherein the port is configured to receiving a component.

14. The device of claim 11, wherein the detector comprises:
a RFID reader; and
at least one antenna, attached to the RFID reader, wherein the antenna is configured to identify an RFID chip attached to the plug-in component.

15. The device of claim 14, wherein the at least one port comprises a plurality of ports each configured to receive a corresponding type of plug-in component.

16. The device of claim 15, wherein the detector comprises:
a plurality of antennas, each capable of detecting an RFID, and
a multiplexer coupled between the plurality of antennas and the RFID reader.

17. The device of claim 16, wherein at least one of the antennas is located near a corresponding one of the ports.

18. The device of claim 15, wherein the output device comprises:
a light positioned near each one of the ports.

19. The device of claim 11, wherein the output device comprises a speaker.

20. The device of claim 11, further comprising:
an interface to connect to a network; wherein the processing component is configured to request and receive information from the network as to how to insert the plug-in device into the port; and wherein the output device is a media player configured to output the information to a user.
